(19) United States
(12) Patent Application Publication
(10) Pub. No.: US 2006/0030481 A1
(43) Pub. Date: Feb. 9, 2006

(54) Exhaust treatment device and methods of making the same

(76) Inventors: William J. LaBarge, Bay City, MI (US); Joseph V. Bonadies, Clarkston, MI (US); Joachim Kupe, Davisburg, MI (US)

Correspondence Address: Paul L. Marshall;Delphi Technologies, Inc., MC 480-410-202, P.O. Box 5052, Troy, MI, 48007, US

(21) Appl. No.: 10/911,773

(22) Filed: Aug. 4, 2004

(51) Int. Cl. B01J 23/54

(52) U.S. Cl. 502/324; 502/339; 502/326

(57) ABSTRACT

An exhaust treatment device comprises a shell; a substrate disposed within the shell, the substrate having a catalyst disposed thereon, wherein the catalyst comprises platinum and a protective layer selected from the group consisting of tin oxide, iron oxide, and manganese oxide, and wherein the catalyst is capable of oxidizing greater than or equal to 50 wt. % carbon monoxide present in an exhaust gas stream at temperatures of about 150° C. to about 200° C.

### BACKGROUND

In order to meet exhaust gas emission standards, the exhaust gas emitted from internal combustion engines is treated prior to emission into the atmosphere. Exhaust gases can be routed through at least one exhaust treatment device disposed in fluid communication with the exhaust outlet system of the engine, wherein the exhaust gases are treated by reactions with a catalyst composition deposited on a porous support material. Examples of exhaust treatment devices include catalytic converters, catalytic absorbers, diesel particulate traps, non-thermal plasma conversion devices, and the like. The exhaust gas generally contains undesirable emission components including carbon monoxide (CO), hydrocarbons (HC), and nitrogen oxides (NO_{X}). As a means of simultaneously removing the objectionable CO, HC, and NO_{X} components, various catalyst compositions have been developed.

The reduction of NO_{X}, e.g., nitric oxide (NO), nitrogen dioxide (NO₂), and nitrous oxide (N₂O), in exhaust gases is a widely addressed problem as a result of environmental concerns and mandated government emissions regulations, particularly in the transportation industry. One approach for treating NO_{X} in exhaust gases is to incorporate a NO_{X} adsorber, also referred to as a “lean-NO_{X} trap,” in the exhaust lines. The NO_{X} adsorber promotes the catalytic oxidation of NO_{X} by utilizing catalytic metal components effective for such oxidation, such as precious metals. The formation of NO₂ is generally followed by the formation of a nitrate when the NO₂ is adsorbed onto the catalyst surface. The NO₂ is thus “trapped”, i.e., stored, on the catalyst surface in the nitrate form. The NO_{X} adsorber can be periodically regenerated by introducing a strong reducing agent (e.g., urea, ammonia, hydrogen, carbon monoxide, and the like) into the NO_{X} adsorber. During regeneration, the absence of oxygen and the presence of reducing agents promote the reduction and subsequent release of the stored nitrogen oxides as nitrogen and water.

However, a portion of these reducing agents can slip past the NO_{X} adsorber. A catalyst placed downstream of a NO_{X} adsorber can be employed to oxidize reducing agents that are not consumed in, for example, regenerating the NO_{X} adsorber. It is noted that these post-NO_{X} cleanup catalysts can have significantly lower operating temperatures compared to the operating temperatures of those exhaust treatment devices located upstream thereof.

A post-NO_{X} clean-up catalyst can comprise an oxidation catalyst, e.g., platinum. However, it is noted that carbon monoxide can strongly attach to the platinum surface. At low temperatures (i.e., temperatures less than or equal to 150° C.), the carbon monoxide “poisoned” platinum has an inability to react with oxygen such that oxidation of the carbon monoxide can proceed.

Therefore, a need remains in the art for an improved catalytic exhaust treatment device capable of carbon monoxide oxidation at low temperatures, i.e., temperatures less than or equal to 150° C., while also being active at temperatures greater than 150° C.

### SUMMARY

One embodiment of an exhaust treatment device comprises a shell; a substrate disposed within the shell, the substrate having a catalyst disposed thereon, wherein the catalyst comprises platinum and a protective layer selected from the group consisting of tin oxide, iron oxide, and manganese oxide, and wherein the catalyst is capable of oxidizing greater than or equal to 50 wt. % carbon monoxide present in an exhaust gas stream at temperatures of about 150° C. to about 200° C.

One embodiment of a method of making an exhaust treatment device comprises disposing a support material on a substrate; disposing platinum and an organometallic tin compound on the support material; sintering the substrate at a temperature for a sufficient time and duration to decompose the organo portion of the organometallic tin compound, such that a protective layer comprising tin oxide forms over the platinum.

One embodiment of a method of making a carbon monoxide oxidation catalyst comprises forming a platinum protective layer bimetallic particle on a support material, wherein the protective layer material is selected from the group consisting of tin, iron, and manganese; heating the supported bimetallic particle to a sufficient temperature to form a catalyst comprising a protective layer on the platinum, wherein the protective layer is selected from the group consisting of tin oxide, iron oxide, manganese oxide; and wherein the catalyst is capable of oxidizing greater than or equal to 50 wt. % carbon monoxide present in an exhaust stream at temperatures of about 150° C. to about 200° C.

The above-described and other features will be appreciated and understood by those skilled in the art from the following detailed description, drawings, and appended claims.

### BRIEF DESCRIPTION OF THE DRAWINGS

Referring now to the figures, which are exemplary embodiments, and wherein the like elements are numbered alike:

FIG. 1 is a partial cross-sectional view of an exhaust treatment device.

FIG. 2 is a schematic illustration of an exemplary catalyst comprising a protective layer.

FIG. 3 is a schematic illustration of an exemplary exhaust treatment system.

### DETAILED DESCRIPTION

Disclosed herein are exhaust treatment devices comprising a catalyst capable of oxidizing greater than or equal to 50 wt. % of carbon monoxide present in an exhaust gas stream at temperatures of about 150° C. to about 200° C. The term “catalyst” as used herein refers to the total solids in a waschcoat, which can include, but is not limited to, precious metal(s), and a protective layer disposed over the precious metal(s).

It should be noted that the terms “first,” “second,” and the like herein do not denote any order quantity, or importance, but rather are used to distinguish one element from another, and the terms “a” and “an” herein do not denote a limitation of quantity, but rather denote the presence of at least one of the referenced item. Furthermore, all ranges disclosed herein are inclusive and combinable (e.g., ranges of “up to about 25 wt. %, with about 5 wt. % to about 20 wt. % desired, and about 10 wt. % to about 15 wt. % more desired,” is inclusive of the endpoints and all intermediate values of the ranges, e.g., “about 5 wt. % to about 25 wt. %, about 5 wt. % to about 15 wt. %”, etc.).

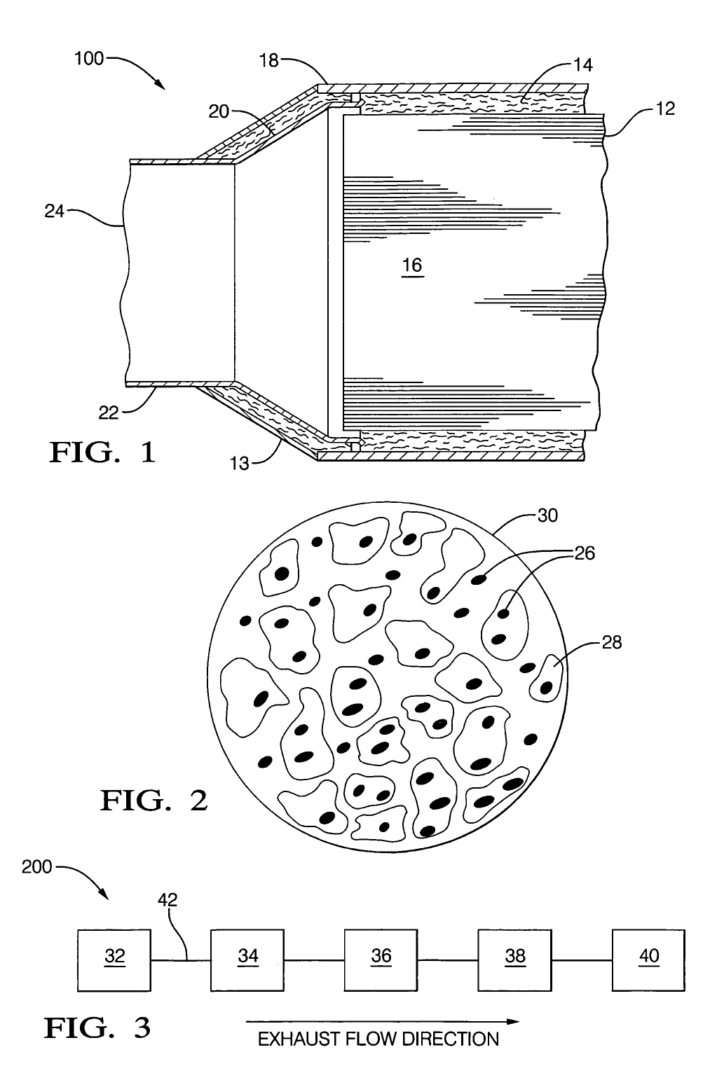

Referring now to FIG. 1, an exemplary embodiment of an exhaust treatment device generally designated 100 is illustrated. The exhaust treatment device 100 can include, but is not limited to, the following examples, catalytic converters, evaporative emissions devices, scrubbing devices (e.g., hydrocarbon, sulfur, and the like), particulate filters/traps, adsorbers/absorbers, non-thermal plasma reactors, and the like, as well as combinations comprising at least one of the foregoing devices. The exhaust treatment device 100 comprises a substrate 12 disposed within a retention material 14 forming a subassembly 16. A shell 18 is disposed around the subassembly 16. An end-cone 20 comprising a snorkel 22 having an opening 24 is in physical communication with shell 18. Opening 24 allows exhaust gas to be in fluid communication with substrate 12. As will be discussed in much greater detail, a catalyst can be disposed on/throughout substrate 12, hereinafter “on” the substrate 12.

Substrate 12 can comprise any material designed for use in a spark ignition or diesel engine environment and having the following characteristics: (1) capable of operating at temperatures up to about 600° C., and up to about 1,000° C. for some applications, depending upon the location of a device within the exhaust system (manifold mounted, close coupled, or underfloor) and the type of system (e.g., gasoline or diesel); (2) capable of withstanding exposure to hydrocarbons, nitrogen oxides, carbon monoxide, particulate matter (e.g., soot and the like), carbon dioxide, and/or sulfur; and (3) having sufficient surface area and structural integrity to support a catalyst. Some possible materials include cordierite, silicon carbide, metal, metal oxides (e.g., alumina, and the like), glasses, and the like, and mixtures comprising at least one of the foregoing materials. Some ceramic materials include “Honey Ceram”, commercially available from NGK-Locke, Inc, Southfield, Mich., and “Celcor”, commercially available from Corning, Inc., Corning, N.Y. These materials can be in the form of foils, perform, mat, fibrous material, monoliths (e.g., a honeycomb structure, and the like), other porous structures (e.g., porous glasses, sponges), foams, pellets, particles, molecular sieves, and the like (depending upon the particular device), and combinations comprising at least one of the foregoing materials and forms, e.g., metallic foils, open pore alumina sponges, and porous ultra-low expansion glasses. Furthermore, these substrates can be coated with oxides and/or hexaaluminates, such as stainless steel foil coated with a hexaaluminate scale.

Although the substrate can have any size or geometry, the size and geometry are preferably chosen to optimize surface area in the given exhaust emission control device design parameters. For example, the substrate can have a honeycomb geometry, with the combs through-channel having any multi-sided or rounded shape, with substantially square, triangular, pentagonal, hexagonal, heptagonal, or octagonal or similar geometries preferred due to ease of manufacturing and increased surface area.

Located between the substrate 12 and the shell 18 can be a retention material 14 that insulates the shell 18 from both the exhaust gas temperatures and the exothermic catalytic reaction occurring within the catalyst substrate 12. The retention material 14, which enhances the structural integrity of the substrate by applying compressive radial forces about it, reducing its axial movement and retaining it in place, can be concentrically disposed around the substrate to form a retention material/substrate subassembly 16.

The retention material 14, which can be in the form of a mat, particulates, or the like, can be an intumescent material (e.g., a material that comprises vermiculite component, i.e., a component that expands upon the application of heat), a non-intumescent material, or a combination thereof. These materials can comprise ceramic materials (e.g., ceramic fibers) and other materials such as organic and inorganic binders and the like, or combinations comprising at least one of the foregoing materials. Non-intumescent materials include materials such as those sold under the trademarks “NEXTEL” and “INTERAM 1101HT” by the “3M” Company, Minneapolis, Minn., or those sold under the trademark, “FIBERFRAX” and “CC-MAX” by the Unifrax Co., Niagara Falls, N.Y., and the like. Intumescent materials include materials sold under the trademark “INTERAM” by the “3M” Company, Minneapolis, Minn., as well as those intumescents which are also sold under the aforementioned “FEBERFRAX” trademark, as well as combinations thereof and others.

The retention material/substrate subassembly 16 can be concentrically disposed within a shell 18. The choice of material for the shell 18 depends upon the type of exhaust gas, the maximum temperature reached by the substrate 12, the maximum temperature of the exhaust gas stream, and the like. Suitable materials for the shell 18 can comprise any material that is capable of resisting under-car salt, temperature, and corrosion. For example, ferrous materials can be employed such as ferritic stainless steels. Ferritic stainless steels can include stainless steels such as, e.g., the 400-Series such as SS-409, SS-439, and SS-441, with grade SS-409 generally preferred.

End cone 20 (or alternatively an end cone(s), end plate(s), exhaust manifold cover(s), and the like), which can comprise similar materials as the shell, can be disposed at one or both ends of the shell. The end cone 20 is sealed to the shell to prevent leakage at the interface thereof. These components can be formed separately (e.g., molded or the like), or can be formed integrally with the housing using methods such as, e.g., a spin forming, or the like.

In an alternative method, for example, the shell can comprise two half-shell components, also known as clamshells. The two half-shell components are compressed together about the retention material/substrate subassembly, such that an annular gap preferably forms between the substrate and the interior surface of each half-shell as the retention material becomes compressed about the substrate.

The exhaust emission treatment device 100 can be manufactured by one or more techniques, and, likewise, the retention material/substrate subassembly 16 can be disposed within the shell 18 using one or more methods. For example, the retention material/substrate subassembly 16 can be inserted into a variety of shells 18 using a stuffing cone. The stuffing cone is a device that compresses the retention material 14 concentrically about the substrate 12. The stuffing cone then stuffs the compressed retention material/substrate subassembly 16 into the shell, such that an annular gap preferably forms between the substrate 12 and the interior surface of the shell 18 as the retention material 14 becomes compressed about the substrate 12. Alternatively, if the retention material 14 is in the form of particles (e.g., pellets, spheres, irregular objects, or the like) the substrate 12 can be stuffed into the shell 18 and the retention material can be disposed in the shell 18 between the substrate 12 and the shell 18.

As briefly mentioned above, a catalyst can be disposed on the substrate 12. The catalyst is capable of oxidizing greater than or equal to 50 wt. % of the carbon monoxide present in an exhaust gas stream at temperatures of about 150° C. to about 200° C. While the catalyst can comprise any precious metal, the catalyst preferably comprises platinum. Without being bound by theory, platinum is the most resistant to oxidation and subsequent particle growth compared to other precious metals. Generally, increased particle growth relates to decreased carbon monoxide oxidation activity at low temperatures. As such, the platinum desirably comprises a platinum particle size sufficient for carbon monoxide oxidation at low temperatures. For example, the platinum preferably comprises a platinum particle size (taken along the major diameter (i.e., the longest diameter)) of less than or equal to 10 nanometers, with about 1 nanometer to about 2 nanometers preferred.

It is noted that platinum generally does not form a stable oxide. The lack of an oxide allows carbon monoxide to strongly attach to the platinum surface. The carbon monoxide can effectively “poison” the platinum surface until higher temperatures are achieved. Accordingly, the catalyst further comprises a protective layer (e.g., tin oxide, iron oxide, and/or manganese oxide) to allow the catalyst to oxidize greater than or equal to 50 wt. % of the carbon monoxide present in an exhaust gas stream at low temperatures.

Referring now to FIG. 2, a schematic illustration of an exemplary catalyst comprising a protective coating is illustrated. The catalyst comprises precious metal particle(s) 26 disposed on a support material 30 with a protective layer 28 disposed over precious metal particles. However, as illustrated in the figure, a portion of the precious metal particles may not be covered with the protective layer 28. Additionally, it is noted that exemplary materials for the protective layer 28 and support material 30 are discussed in greater detail below.

The protective layer can have a thickness sufficient to allow the platinum to be active while being protected from carbon monoxide deactivation at low temperatures. Preferably, the protective layer has a thickness of less than or equal to 10 nanometers (nm), with a thickness of about 1 nm to about 2 nm preferred. When the protective layer is less than or equal to 2 nanometers, the platinum can still be active for carbon monoxide oxidation. Further, it is noted that the combined effect of platinum and tin oxide can advantageously be used to dehydrogenated water in an exhaust stream to form hydroxyl, which can be beneficial in low temperature oxidative removal of carbon monoxide.

The protective layer disclosed herein is different than a layer comprising a strong metal support interaction (SMSI) oxide, such as rubidium (Ru), iridium (Ir), silicon (Si), titanium (Ti), zirconium (Zr), vanadium (V), niobium (Nb), and molybdenum (Mo) which can decrease the platinum oxidation at temperatures of about 150° C. In contrast to SMSI oxides, the tin oxide protective layer over the platinum actually increases the activity of platinum at low temperatures.

As discussed above, platinum surfaces in contact with carbon monoxide are deactivated by the carbon monoxide at low temperatures. Since tin oxide forms a protective layer over the platinum, the platinum is able to convert a portion of carbon monoxide (CO) (e.g., greater than or equal to 50 wt. % of the CO present in an exhaust stream) at low temperatures, whereas platinum without the protective tin layer would be inactive. Not to be limited by theory, it is believed that the protective layer material, during sintering, oxidizes and migrates to the surface of the catalyst as an oxide. The protective oxide on the catalyst surface (1) maintains the precious metal at a desired particle size (e.g., less than or equal to 2 nm) even after extended aging (e.g., for greater than or equal to 50 hrs at a temperature of about 400° C.), and (2) enables the catalyst to readily react with carbon monoxide at temperatures of 25° C. thru 300° C., (e.g., greater than or equal to 50 wt. % CO oxidation).

For example, in an embodiment, the platinum and protective layer materials can be co-deposited onto the support material. The protective layer materials can be in the form of a soluble organometallic compound. Suitable organometallic compounds have the general formula:
[R]₃₋₄X[A]₀₋₁
wherein X is tin, iron or manganese; each R is independently a C₁-C₄₀ alkyl, or a substituted C₁-C₄₀ alkyl, and wherein the alkyl substituents comprise an alkoxy, an alkenyl, an alkynyl, a cycloalkyl, a cycloalkenyl, an acyl, a phenyl, a halosubstituted phenyl, a heteroaryl, or a combination comprising at least one of the foregoing substituents; and wherein A is a hydroxyl. Suitable trialkyl tin compounds include, for example, trimethyl tin hydroxide, tributyl tin hydroxide, trioctyl tin hydroxide and the like. Suitable tetraalkyl tin compounds include, for example, tetramethyl tin, tetraethyl tin, tetra-n-butyl tin, tetra-n-octyl tin, and the like. Other exemplary compounds include carboxylic acid type organometallic tin compounds such as (C₄H₉)₂Sn(OCOC₁₁H₂₃)₂; mercaptide type organometallic tin compounds such as (C₄H₉)₂Sn(SCH₂COOC₈H₁₇)₂; sulfide type organometallic tin compounds such as (C₄H₉)₂Sn═S; organometallic tin oxides such as (C₄H₉)₂SnO; and chloride type organometallic tin compounds such as (C₄H₉)₂SnCl₃.

In an embodiment, the catalyst metal (e.g., platinum) and protective layer can be formed, for example, by first depositing an organometallic precious metal precursor and then decomposing the precious metal precursor by heat treatment at a temperature of about 120° C. to about 180° C. Once the precious metal deposits have been disposed on the support, the protective layer can be deposited as an organometallic protective layer precursor and then decomposed by heat treatment at a temperature of about 250° C. to about 350° C. to form the protective layer. In other embodiments, the precious metal precursor and protective layer precursor can be organic acids such as acetates, citrates, and mixtures comprising at least one of the foregoing. In these embodiments, alcohols or a water-alcohol mixture comprising about 1 wt. % to about 20 wt. % water are preferably used as the solvents, wherein weight percents are based on a total weight of the mixture. The precipitation reactions can occur by addition of the acidic precursor solution to water or water-ammonium hydroxide mixtures comprising about 1 wt. % to about 30 wt. % ammonium hydroxide, wherein weight percents are based on a total weight of the mixture.

In addition to the support and catalyst compounds, the catalyst can comprise stabilizer(s), binder(s), promoter(s), and the like. The catalyst can be washcoated, imbibed, impregnated, physisorbed, chemisorbed, precipitated, or otherwise applied onto and/or within the substrate.

The catalyst is supported on a support material(s). Such support materials include, but are not limited to, gamma aluminum oxide, delta aluminum oxide, theta aluminum oxide, stabilized aluminum oxides, titanium oxides, zirconium oxides, zeolites, as well as combinations comprising at least one of the foregoing. It is further noted that the support oxides can comprise solid solutions of metal oxides. Particularly, lanthanum stabilized (gamma-delta phase) aluminum oxide, a titanium-zirconium solid solution, or a combination comprising at least one of these support materials can be employed. For example, a molar ratio of gamma-delta aluminum oxide to titanium-zirconium solid solution can be about 100:0 to about 60:40.

Solid solutions support material can be formed in a manner similar to that described above for the catalyst metal. For example, organometallic precursors can be mixed and then subsequently decomposed to form the solid solution. Preferably, the organometallic precursors can be formed by a hydrolytic process based on the etherification of alcohols. For example, titanium and/or a titanium salt can be reacted with an alcohol to form titanium alkoxide. The metal alkoxides can then be combined to form the organometallic precursors. Decomposition can comprise adding water (e.g., preferably slowly (e.g., drop wise)), and/or evaporation. The solid solution can then be applied to the substrate.

While the platinum/tin oxide can be washcoated on substrate as a slurry comprising the platinum/tin oxide and the support material, the platinum/tin oxide is preferably post-impregnated on the support material. In other embodiments, the precious metal(s) can be incorporated into the solids comprising the washcoat. In other words, the precious metal, for example, platinum, can occupy the same crystalline structure as the components making up the washcoat, for example, yttrium, zirconium, lanthanum, and/or titanium. Incorporating the precious metal into solid solutions can improve the initial dispersion of the precious metals. Without being bound by theory, these effects can be realized because a solid solution has unique physical properties compared to the physical properties of the individual components making up the solid solution.

In those embodiments where the catalyst is applied to the substrate as a slurry, the substrate can be heated to a sufficient temperature for a sufficient time to calcinate the catalyst. For example, the substrate can be heated to a temperature of about 300° C. to about 800° C. for a period of about 10 minutes to about 4 hours. Preferably, calcining occurs in a water-containing atmosphere. For example, a relative humidity during calcining (at the furnace temperature) of greater than or equal to 20%, with greater than or equal to 40% preferred, and greater than or equal to 60% more preferred.

The catalyst can further comprise a solid solution comprising yttrium, zirconium, lanthanum, and titanium. These components can be present in any ratio and have any particle size such that a solid solution is formed that is capable of being used in a washcoated catalyst. For example, a molar ratio of zirconium to titanium can be about 20:80 to about 80:20. The molar ratio of yttrium to zirconium can be about 8:92 to about 0:100. The molar ratio of lanthanum to titanium can be about 8:92 to about 0:100.

It is further noted that the catalyst can comprise stabilizer(s). Possible stabilizers include, but are not limited to, lanthanide series elements, with yttrium and lanthanum preferred. The stabilizer(s) preferably have a particle diameter, measured along the major axis, of less than or equal to 0.6 micrometers, with less than or equal to 0.25 micrometers preferred, and less than or equal to 0.1 micrometers more preferred.

The catalyst preferably has a loading sufficient to reduce the carbon monoxide poisoning of platinum at low temperatures and to obtain the desired activity. For example, the catalyst can be employed at about 0.5 grams per cubic inch (g/in³) (about 0.03 grams per cubic centimeter (g/cm³)) to about 6.0 g/in³ (about 0.4 g/cm³), based on the volume of the substrate. Within this range, greater than or equal to 1.0 g/in³ (about 0.06 g/cm³) is preferred, more preferably greater than or equal to 2.0 g/in³ (about 0.1 g/cm³), and most preferably greater than or equal to 3.0 g/in³ (about 0.2 g/cm³). Also within this range, less than or equal to 6.0 g/in³ (about 0.4 g/cm³) is preferred, more preferably less than or equal to 5.0 g/in³ (about 0.3 g/cm³), and most preferably less than or equal to 4.0 g/in³ (about 0.2 g/cm³).

The catalytic metal loadings (e.g., platinum) are based upon sufficient platinum to attain the desired activity, and sufficient protective layer to obtain the desired activity at low temperatures. For example, the catalyst can comprise about 0.05 wt. % to about 4.0 wt % for each catalytic metal, wherein the weight percent is based on the total weight of the catalyst, which includes support material(s) and catalytic metal(s). The total catalytic metal loading is preferably about 0.2 wt. % to about 0.8 wt. %. Preferably, in an embodiment, a ratio of platinum to protective layer material (i.e., tin, manganese, and/or iron) is about 0.10:1 to about 2:1, with about 1:1 preferred. For example, the catalyst can comprise a platinum loading of about 0.4 wt. % and a tin loading of about 2.0 wt. %. Further, the platinum and protective layer material can each have a loading of about 0.03 g/in³ (about 0.0012 g/cm³) to about 0.06 g/in³ (about 0.0037 g/cm³). The amount of protective layer material is dependent upon the amount of precious metal (e.g., platinum). A sufficient amount of the protective layer material to enhance the oxidation activity of the catalyst at about 150° C. to about 200° C. to greater than or equal to 50 wt. % (with greater than or equal to 80 wt. % desired) based upon the total weight of carbon monoxide in the stream contacting the catalyst, is employed. The upper limit on the amount of protective layer material is the amount where the oxidation activity of the catalyst is less than 50 wt. % at 250° C. Generally, sufficient protective material is employed to form a protective layer on the platinum of about 1 μm to about 2 nm thick.

In an embodiment, the catalyst is washcoated onto the substrate as a slurry. The slurry comprises a catalyst metal(s) (e.g., platinum), a protective layer material (e.g., tin), support material(s) (e.g., gamma aluminum oxide), an organic vehicle, and optional stabilizer(s). The organic vehicle can include, but is not limited to, methyl ethyl ketone, toluene, xylene, ethanol, hexane, ethyl acetate, trichloroethylene, isopropanol, and a combination comprising at least one of the foregoing. The stabilizer can include, but is not limited to, calcium, barium, yttrium, magnesium, aluminum, lanthanum, cesium, gadolinium, and the like, as well as oxides, alloys, and combinations comprising at least one of the foregoing materials.

The pH of the slurry is controlled to attain and maintain a desired viscosity. Preferably, a slurry pH of less than or equal to 5 is employed, with a pH of about 2.5 to about 4.8 preferred. The pH can be adjusted by adding acetate, e.g., ammonium acetate (NH₄(C₂H₃O₂)) to the slurry. The slurry can be applied as a washcoat to at least a portion of the substrate (e.g., 16). For example, the washcoat can be applied to the substrate by a variety of techniques, including dipping, immersion, spraying, painting, and the like.

Due to the catalyst's affinity for the oxidation of carbon monoxide, and activity at low temperatures, this catalyst is particularly useful in an underfloor position, and specifically an underfloor position, in a diesel exhaust system, downstream of a NO_{X} treatment device. Referring now to FIG. 3, an exemplary exhaust treatment system generally designated 200 is illustrated. An oxidation catalyst 34, particulate filter 36, NO_{X} adsorber 38, and carbon monoxide catalyst 40 (e.g., the catalyst disclosed herein) are in direct fluid communication with an engine 32 through exhaust conduit 42. Reformate (e.g., hydrogen, carbon monoxide, partially oxidized organics such as the light gasses methane, ethane, propane, and butane) from a reformer (not shown) can be selectively directed to oxidation catalyst 34, particulate filter 36, NO_{X} adsorber 38 and carbon monoxide catalyst 40. The reformate (e.g., primarily hydrogen and carbon monoxide) can be used to regenerate oxidation catalyst 34, particulate filter 36, and/or NO_{X} adsorber 38. Any carbon monoxide not consumed in the reduction process (e.g., any carbon monoxide passing through NO_{X} adsorber 38, can be catalyzed to carbon dioxide and water by carbon dioxide catalyst 40.

### EXAMPLES

### Example 1

### Pt/Sn/La_{0.03}Al_{0.97}

A slurry was prepared by adding 4,800 grams lanthanum stabilized gamma-delta aluminum oxide doped with 3 wt. % lanthanum; wherein weight percent of lanthanum is based on a total weight of the lanthanum stabilized gamma-delta aluminum oxide; 1,120 grams zirconium acetate; 1,470 grams aluminum nitrate; and 5,200 grams distilled water. The mixture was high shear mixed for 20 minutes. The mixed slurry was attrition milled for 2 hours. The coating was applied to a 4.66 inch round, 3-inch long ceramic monolith consisting of 600 cells per square inch. DimethyPlatinum(II) tetramethylethylenediamine was impregnated on the lanthanum stabilized gamma-Al₂O₃ washcoat. The impregnated substrate/catalyst was dried and calcined at a temperature of about 250° C. to about 400° C. using microwaves. The Pt/LaAl₂O₃ was impregnated with a tris n-butyl-tin hydroxide and ethanol solution. The impregnated catalyst was dried in a box furnace at 80° C. for 4 hours and then calcined at 280° C. for 4 hours. A tin loading of 1.04 wt. % loading was obtained after calcination, wherein weight percent is based on a total weight of the catalyst. The finished powder comprised 0.25 wt. % catalytic metal Pt deposited upon 4.40 wt. % Y₂O₃, 55.41 wt. % ZrO₂ and 38.62 wt. % TiO₂ catalyst support and coated over with 1.32 wt. % SnO₂ catalyst protective layer.

### Example 2

### Pt/Sn/Y_{0.04}Zr_{0.46}Ti_{0.50}

Yttrium-zirconium-titanium powder as described in Example 1, was doped with dimethyPlatinum(II) tetramethylethylenediamine and calcined at 500° C. for 4 hours. A 0.25 wt. % loading of platinum was obtained after calcination, wherein weight percents are based on a total weight of the catalyst. The Pt/lanthanum stabilized gamma-delta aluminum oxide powder was doped with tris n-butyl-tin hydroxide and calcined at 280° C. for 4 hours. A 0.89 wt. % loading of tin was obtained after calcination, wherein weight percent is based on a total weight of the catalyst. The finished powder comprised 0.25 wt. % catalytic metal Pt deposited upon 4.42 wt. % Y₂O₃, 55.52 wt. % ZrO₂ and 38.68 wt. % TiO₂ catalyst support and coated over with 1.13 wt. % SnO₂ catalyst protective layer.

### Example 3

### Pt/Sn/La_{0.03}Al_{0.97}—Pt/Sn/Y_{0.04}Zr_{0.46}Ti_{0.50}

Lanthanum stabilized gamma-delta aluminum oxide powder as described in Example 1, was doped with dimethyPlatinum(II) tetramethylethylenediamine and calcined at 500° C. for 4 hours. A 0.25 wt. % loading of platinum was obtained after calcination, wherein weight percent is based on a total weight of the fired catalyst. The Pt/lanthanum stabilized gamma-delta aluminum oxide powder was doped with tris n-butyl-tin hydroxide and calcined at 280° C. for 4 hours. A 0.73 wt. % loading of tin was obtained after calcination. The finished powder comprised 0.25 wt. % catalytic metal Pt deposited upon 89.16 wt. % Al₂O₃ and 9.68 wt. % La₂O₃ catalyst support and coated over with 0.91 wt. % SnO₂ catalyst protective layer, wherein weight percents are based on a total weight of the finished powder.

Yttrium-zirconium-titanium powder as described in Example 2, was doped with dimethyPlatinum(II) tetramethylethylenediamine and calcined at 500° C. for 4 hours. A 0.25 wt. % loading of platinum was obtained after calcination. The Pt/lanthanum stabilized gamma-delta aluminum oxide powder was doped with tris n-butyl-tin hydroxide and calcined at 280° C. for 4 hours. A 0.89 wt. % loading of tin was obtained after calcination. The finished powder comprised 0.25 wt. % catalytic metal Pt deposited upon 4.42 wt. % Y₂O₃, 55.52 wt. % ZrO₂ and 38.68 wt. % TiO₂ catalyst support and coated over with 1.13 wt. % SnO₂ catalyst protective layer, wherein weight percents are based on a total weight of the finished powder.

A ceramic monolith was coated with 7.0 g/in³ (about 0.43 g/cm³) slurry containing solids of 62 wt. % Pt/Sn/La_{0.03}Al_{0.97}, 29 wt. % Pt/Sn/Y_{0.04}Zr_{0.46}Ti_{0.50}, 4 wt. % aluminum nitrate, and 5 wt. % zirconium acetate, wherein weight percents are based on a total weight of the solids present in the slurry. The monolith with washcoat was calcined at 280° C. for 4 hours. The finished monoliths had a washcoat of 2.41 g/in³ (about 0.15 g/in³) Pt/Sn/La_{0.03}Al_{0.97}, 1.13 g/in³ (about 0.07 g/cm³) Pt/S/Y_{0.04}Zr_{0.46}Ti_{0.50}, 0.16 g/in³ (about 0.01 g/cm³) Al₂O₃, and 0.19 g/in³ (about 0.01 g/cm³) zirconium oxide.

Advantageously, the exhaust treatment device comprising the catalyst disclosed herein can be used downstream of a NO_{X} treatment device (e.g., a NO_{X} adsorber) and/or a SCR catalyst, since it has increased activity a low temperatures. For example, the catalyst is capable of oxidizing greater than or equal to about 50 wt. % of the carbon monoxide present in an exhaust gas stream at catalyst (e.g., carbon monoxide catalyst 40) exit temperatures of about 150° C., with greater than or equal to 70 wt. % oxidized at temperatures greater than or equal to 200° C. This low temperature activity is a great improvement over other platinum catalysts where platinum is in direct contact with the carbon monoxide. In comparison, those catalysts can be deactivated by CO thereby having an activity of less than 20 wt. % carbon monoxide oxidized at a temperature of 150° C. The catalyst disclosed herein exhibits an ability to oxidize greater than or equal to about 80 wt. % carbon monoxide, and even greater than or equal to about 90 wt. % carbon monoxide at temperatures of about 120° C. to about 130° C., and even up to temperatures of about 180° C. In other words, the present catalyst maintains a carbon monoxide oxidation capability of greater than or equal to 50 wt. %, based upon the total weight of carbon monoxide in a stream contacting the catalyst, at temperatures of about 25° C. to about 350° C.; and even an oxidation of greater than or equal to 80 wt. % carbon monoxide at temperatures of about 250° C. to about 350° C. Additionally, platinum particle growth is inhibited by the tin oxide, thereby increasing the aged activity of the catalyst. In other words, the catalyst life can be extended compared to other catalysts where platinum grain growth is substantially increased.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An exhaust treatment device comprising:
a shell;
a substrate disposed within the shell, the substrate having a catalyst disposed thereon, wherein the catalyst comprises platinum and a protective layer selected from the group consisting of tin oxide, iron oxide, and manganese oxide, and wherein the catalyst is capable of oxidizing greater than or equal to 50 wt. % carbon monoxide present in an exhaust gas stream at temperatures of about 150° C. to about 200° C.

2. The exhaust treatment device of claim 1, wherein the protective layer is tin oxide.

3. The exhaust treatment device of claim 1, wherein protective layer has a thickness of less than or equal to 10 nm.

4. The exhaust treatment device of claim 3, wherein the thickness is about 1 nm to about 2 nm.

5. The exhaust treatment device of claim 1, wherein the platinum has a platinum particle size of less than or equal to 10 nanometers.

6. The exhaust treatment device of claim 1, wherein the catalyst further comprises tin, and wherein the platinum and tin each having a loading of about 0.1 wt. % to about 4.0 wt. %, based on the total weight of the catalyst.

7. The exhaust treatment device of claim 1, wherein the catalyst is capable of oxidizing greater than or equal to 80 wt. % carbon monoxide present in the exhaust gas stream at temperatures of about 250° C. to 350° C.

8. The exhaust treatment device of claim 1, wherein the catalyst is capable of oxidizing greater than or equal to 50 wt. % carbon monoxide present in the exhaust gas stream at temperatures of about 25° C. to 350° C.

9. The exhaust treatment device of claim 1, wherein the catalyst further comprises a solid solution support material, wherein the solid solution support material comprises lanthanum stabilized gamma-delta phase aluminum oxide, a titanium-zirconium solid solution, or a combination comprising at least one of the foregoing.

10. The exhaust treatment device of claim 9, wherein a molar ratio of gamma-delta aluminum oxide to titanium-zirconium solid solution is about 100:0 to about 60:40.

11. The exhaust treatment device of claim 1, further comprising a solid solution comprising solid solution comprising yttrium, zirconium, lanthanum, and titanium.

12. A method of making an exhaust treatment device comprising:
disposing a support material on a substrate;
disposing platinum and an organometallic tin compound on the support material;
sintering the substrate at a temperature for a sufficient time and duration to decompose the organo portion of the organometallic tin compound, such that a protective layer comprising tin oxide forms over the platinum.

13. The method of claim 12, wherein the organometallic tin compound has the general formula:
[R]₃₋₄X[A]₀₋₁
wherein X is tin, manganese, or iron; each R is independently a C₁-C₄₀ alkyl, or a substituted C₁-C₄₀ alkyl, and wherein the alkyl substituents comprise an alkoxy, an alkenyl, an alkynyl, a cycloalkyl, a cycloalkenyl, an acyl, a phenyl, a halosubstituted phenyl, a heteroaryl, or a combination comprising at least one of the foregoing substituents; and wherein A is a hydroxyl.

14. The method of claim 12, wherein the organometallic tin compound is selected from the group consisting of carboxylic acid type organometallic tin compounds; mercaptide type organometallic tin compounds; sulfide type organometallic tin compounds; organometallic tin oxides; and chloride type organometallic tin compounds.

15. The method of claim 14, wherein the organometallic tin compound is selected from the group consisting of (C₄H₉)₂Sn(OCOC₁₁H₂₃)₂, (C₄H₉)₂ Sn(SCH₂COOC₈H₁₇)₂, (C₄H₉)₂Sn═S, (C₄H₉)₂SnO, and (C₄H₉)₂SnCl₃.

16. A method of making a carbon monoxide oxidation catalyst, comprising:
forming a platinum protective layer bimetallic particle on a support material, wherein the protective layer material is selected from the group consisting of tin, iron, and manganese;
heating the supported bi-metallic particle to a sufficient temperature to form a catalyst comprising a protective layer on the platinum, wherein the protective layer is selected from the group consisting of tin oxide, iron oxide, manganese oxide; and wherein the catalyst is capable of oxidizing greater than or equal to 50 wt. % carbon monoxide present in an exhaust stream at temperature of about 150° C. to about 200° C.

17. The method of claim 16, wherein forming the platinum-protective bimetallic particle further comprises:
depositing the support material onto a substrate; and then co-depositing a platinum precursor and an organometallic protective layer precursor onto the support material.
